(19) United States
(12) Patent Application Publication
(10) Pub. No.: US 2025/0189834 A1
(43) Pub. Date: Jun. 12, 2025

(54) POLARIZATION DICHROISM-BASED PUBLIC/PRIVACY DISPLAY PANELS

(71) Applicant: VISTEON GLOBAL TECHNOLOGIES, INC., Van Buren Township, MI (US)

(72) Inventor: Pawel Murzyn, Chelmsford (GB)

(73) Assignee: VISTEON GLOBAL TECHNOLOGIES, INC., Van Buren Township, MI (US)

(21) Appl. No.: 18/976,871

(22) Filed: Dec. 11, 2024

Related U.S. Application Data
(60) Provisional application No. 63/609,332, filed on Dec. 12, 2023.

(51) Int. Cl. G02F 1/13; G02F 1/1335; G02F 1/13357; G02F 1/13363

(52) U.S. Cl. CPC G02F 1/1323; G02F 1/133531; G02F 1/133638; G02F 1/133603

(57) ABSTRACT

A display panel includes a polarizer, a liquid crystal retarder, a passive dichroic dye film, and a display. The polarizer transfers a light with a polarization in an orientation. The liquid crystal retarder transfers the light in response to a control signal. A private mode maintains the polarization and the orientation of the light. A public mode rotates the polarization and the orientation of the light. The light with a first polarization in the private mode is absorbed by the passive dichroic dye film for off-axis incident angles in the first direction and transmitted for normal incidence angle and off-axis incidence angles in the second direction. The light with a second polarization in the public mode is transmitted for normal incidence angle and off-axis incidence angles in the first direction and absorbed for off-axis incidence in the second direction. The display is operational to generate an image in the light.

### CROSS-REFERENCE TO RELATED APPLICATIONS

This application claims the benefit of U.S. Provisional Application No. 63/609,332 filed Dec. 12, 2023, which is hereby incorporated by reference in its entirety.

### TECHNICAL FIELD

The present disclosure generally relates to visibility of electronic displays, and in particular to polarization dichroism-based display panels with a public mode and a privacy mode.

### BACKGROUND

Console-based display panels are becoming more popular in automobiles. The display panels are commonly intended for use by a driver of the automobile and a passenger sitting next to the driver. Several active privacy solutions are offered by automotive display and backlight suppliers. None of the existing solutions are currently available for applications involving full area local dimming (FALD/matrix backlighting) and organic light-emitting diodes (OLED), mainly due to a reliance on switchable backlights. In addition, most of the existing solutions involve a power consumption due to multiple stacked displays and color shift relative to a viewing angle.

### SUMMARY

A display panel is provided herein. The display panel includes a first polarizer, a first liquid crystal retarder, a passive dichroic dye film, and a display. The first polarizer is operational to transfer a light with a first polarization oriented in a first direction. The first liquid crystal retarder is mounted adjacent to the first polarizer. The first liquid crystal retarder transfers the light received from the first polarizer in response to a control signal. The control signal is switchable between a private mode and a public mode. The private mode maintains the first polarization of the light oriented in the first direction. The public mode rotates the first polarization of the light to a second polarization oriented in a second direction.

The passive dichroic dye film is mounted adjacent to the first liquid crystal retarder. The light with the first polarization in the private mode is absorbed by the passive dichroic dye film for off-axis incident angles in the first direction and transmitted for a normal incidence angle and the off-axis incidence angles in the second direction. The light with the second polarization in the public mode is transmitted for the normal incidence angle and the off-axis incidence angles in the first direction and absorbed for the off-axis incidence angles in the second direction. The display is mounted adjacent to one of the passive dichroic dye film or the first polarizer, and operational to generate an image in the light in response to a display signal. A private viewing angle of the image in the private mode is narrower than a public viewing angle of the image in the public mode.

In one or more embodiments of the display panel, the display is a thin-film transistor display.

In one or more embodiments, the display panel includes a second polarizer mounted between the first polarizer and the display. The display is an organic light-emitting diode display and the second polarizer is a circular polarizer, or the display is a micro light-emitting diode display and the second polarizer is a linear polarizer.

In one or more embodiments of the display panel, the first polarization is a horizontal polarization oriented in a horizontal direction. The second polarization is a vertical polarization oriented in a vertical direction. The passive dichroic dye film has a linear polarization dichroism.

In one or more embodiments, the display panel includes a quarter-wave plate disposed between the first liquid crystal retarder and the passive dichroic dye film.

In one or more embodiments of the display panel, the passive dichroic dye film has a circular polarization dichroism.

In one or more embodiments of the display panel, the circular polarization dichroism is a left-hand polarization.

In one or more embodiments of the display panel, the circular polarization dichroism is a right-hand polarization.

In one or more embodiments, the display panel includes a compensation layer mounted between the first liquid crystal retarder and the passive dichroic dye film.

In one or more embodiments, the display panel includes a backlight source mounted adjacent to the first polarizer and operational to generate the light.

A display panel is provided herein. The display panel includes a first polarizer, an active privacy cell, and a display. The first polarizer is operational to transfer a light with a first polarization oriented in a first direction. The active privacy cell mounted adjacent to the first polarizer. The active privacy cell transfers the light received from the first polarizer in response to a control signal. The active privacy cell includes a second liquid crystal retarder doped with active dichroic dye particles. The second liquid crystal retarder has a director axis that is adjustable with the control signal. The active dichroic dye particles have a dye absorption axis that is adjustable with the control signal.

The control signal is switchable between a private mode and a public mode. In the private mode the light with the first polarization is transmitted for a normal incidence angle and is blocked for off-axis incidence angles. In the public mode the light with the first polarization is transmitted for the normal incidence angle and is transmitted for the off-axis incidence angles. The display is mounted adjacent to one of the active privacy cell or the first polarizer and operational to generate an image in the light in response to a display signal. A private viewing angle of the image in the private mode is narrower than a public viewing angle of the image in the public mode.

In one or more embodiments of the display panel, the display is a thin-film transistor display.

In one or more embodiments, the display panel includes a second polarizer mounted between the first polarizer and the display. The display is an organic light-emitting diode display and the second polarizer is a circular polarizer, or the display is a micro light-emitting diode display and the second polarizer is a linear polarizer.

In one or more embodiments of the display panel, the first polarization is a horizontal polarization oriented in a horizontal direction.

In one or more embodiments of the display panel, liquid crystal directors of the second liquid crystal retarder and a die absorption axis of the active dichroic dye particles are oriented normal to a surface of the second liquid crystal retarder in the private mode.

In one or more embodiments, the display panel includes a compensated half-wave plate mounted between the active privacy cell and the display.

In one or more embodiments, the display panel includes a quarter-wave plate disposed between the first polarizer and the active privacy cell. The active dichroic dye particles have a circular polarization dichroism.

In one or more embodiments of the display panel, a cut-off angle of the active privacy cell is based on a tilt angle of the dye absorption axis.

In one or more embodiments of the display panel, the active privacy cell includes a counter tile angle symmetrical to the tilt angle to establish a transmission peak at normal incidence.

The above features and advantages and other features and advantages of the present teachings are readily apparent from the following detailed description of the best modes for carrying out the teachings when taken in connection with the accompanying drawings.

### BRIEF DESCRIPTION OF THE DRAWINGS

FIG. 1 illustrates a context of a platform in accordance with one or more exemplary embodiments.

FIG. 2 illustrates a schematic diagram of an operation of linear polarization dichroism in accordance with one or more exemplary embodiments.

FIG. 3 illustrates a schematic side view of a first switchable privacy stack in a private mode in accordance with one or more exemplary embodiments.

FIG. 4 illustrates a diagram of a transmittance of the first switchable privacy stack in the private mode in accordance with one or more exemplary embodiments.

FIG. 5 illustrates a schematic side view of the first switchable privacy stack in the public mode in accordance with one or more exemplary embodiments.

FIG. 6 illustrates a diagram of a transmittance of the first switchable privacy stack in the public mode in accordance with one or more exemplary embodiments.

FIG. 7 illustrates a schematic side view of a first embodiment of a display panel in accordance with one or more exemplary embodiments.

FIG. 8 illustrates a schematic side view of a second embodiment of the display panel in accordance with one or more exemplary embodiments.

FIG. 9 illustrates a schematic side view of a third embodiment of the display panel in accordance with one or more exemplary embodiments.

FIG. 10 illustrates a schematic side view of a fourth embodiment of the display panel in accordance with one or more exemplary embodiments.

FIG. 11 illustrates a schematic side view of a second switchable privacy stack in the private mode in accordance with one or more exemplary embodiments.

FIG. 12 illustrates a diagram of a transmittance of the second switchable privacy stack in the private mode in accordance with one or more exemplary embodiments.

FIG. 13 illustrates a schematic side view of the second switchable privacy stack in the public mode in accordance with one or more exemplary embodiments.

FIG. 14 illustrates a diagram of a transmittance of the second switchable privacy stack in the public mode in accordance with one or more exemplary embodiments.

FIG. 15 illustrates a schematic side view of a fifth embodiment of the display panel in accordance with one or more exemplary embodiments.

FIG. 16 illustrates a schematic side view of a sixth embodiment of the display panel in accordance with one or more exemplary embodiments.

FIG. 17 illustrates a schematic side view of a seventh embodiment of the display panel in accordance with one or more exemplary embodiments.

FIG. 18 illustrates a schematic side view of another embodiment of the second liquid crystal retarder in accordance with one or more exemplary embodiments.

The present disclosure may have various modifications and alternative forms, and some representative embodiments are shown by way of example in the drawings and will be described in detail herein. Novel aspects of this disclosure are not limited to the particular forms illustrated in the above-enumerated drawings. Rather, the disclosure is to cover modifications, equivalents, and combinations falling within the scope of the disclosure as encompassed by the appended claims.

### DETAILED DESCRIPTION

Embodiments of the disclosure generally provide for a polarization dichroism-based display panel operational to generate an optical output signal conveying a plurality of images. The optical signal may be transitioned between a private viewing angle (or mode) of operation and a public viewing angle (or mode) of operation. In various embodiments, the transition may be a discrete step between the private viewing angle and the public viewing angle. In other embodiments, the transition may be continuous between the private viewing angle and the public viewing angle. While in the private viewing angle of operation, the optical output signal may have a narrow viewing range limited to a few tens of degrees (e.g., ±25 degrees) from a normal line incident to a surface of the display panel. While in the public viewing angle of operation, the optical output signal may have a wide viewing range (e.g., ±60 degrees) about the normal line incident to the surface of the display panel.

In various embodiments, the display panel implements a thin-film transistor (TFT) display to create the images and a separate backlight source (either edge or matrix backlighting) to create the light. In other embodiments, the display panel implements an organic light-emitting diode (OLED) display or a micro light-emitting diode (uLED) display that generates and presents the light and the images in the optical output signal. In various embodiments, a liquid crystal (LC) retarder and a passive dichroic dye film are disposed in the path of the light. In some embodiments, active dichroic dye particles are infused (or doped) into the liquid crystal retarder.

The liquid crystal retarder (or liquid crystal cells) acts as a polarization state switch. The passive dichroic dye film acts as a polarization filter. In various embodiments, while the liquid crystal retarder is controlled to be in a private mode, the liquid crystal retarder maintains a first polarization (e.g., a horizontal polarization) of the light oriented in a first direction (e.g., a horizontal direction). While the liquid crystal retarder controlled to be in a public mode, the liquid crystal retarder rotates the first polarization of the light to a second polarization (e.g., a vertical polarization) that is oriented in a second direction (e.g., a vertical direction).

In some embodiments where the liquid crystal retarder is doped with the active dichroic dye particles, while the liquid crystal retarder controlled to be the private mode, the liquid crystal retarder transmits the light with normal incidence and blocks the light with off-axis incidence. While controlled to a public mode, the liquid crystal retarder transmits the light with normal incidence and transmits the light with off-axis incidence.

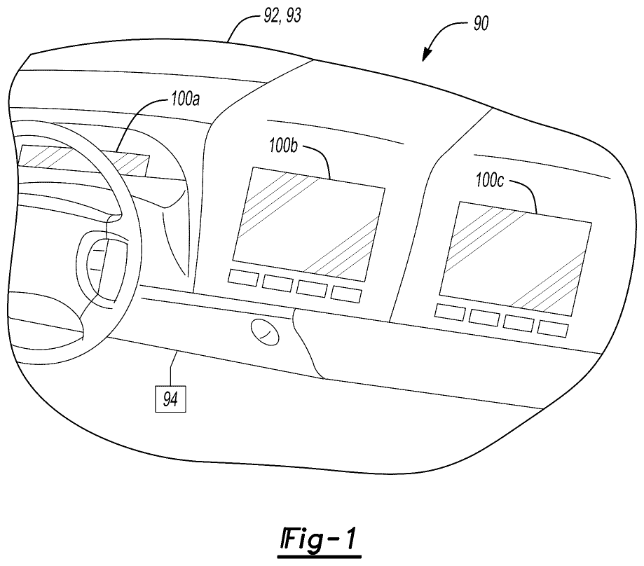

FIG. 1 illustrates a context of a platform 90 in accordance with one or more exemplary embodiments. The platform 90 generally includes an instrument panel 92. The instrument panel 92 includes a control unit 94 and one or more display panels 100a-100c. The instrument panel 92 may be implemented as part of a vehicle 93. The vehicle 93 may include mobile vehicles such as automobiles, trucks, motorcycles, boats, trains and/or aircraft. In some embodiments, the instrument panel 92 may be part of a stationary object. The stationary objects may include, but are not limited to, billboards, kiosks, and/or marquees. Other types of platforms 90 may be implemented to meet the design criteria of a particular application.

The control unit 94 implements one or more display-drive circuits. The control unit 94 is generally operational to generate control signals that drive the display panels 100a-100c. In various embodiments, the control signals may be configured to provide instrumentation (e.g., speed, tachometer, fuel, temperature, etc.) to at least one display panel 100a-100c (e.g., 100a). In some embodiments, the control signals may also be configured to provide video (e.g., a rear-view camera video, a forward-view camera video, an onboard DVD player, etc.) to the display panels 100a-100c. In other embodiments, the control signals may be further configured to provide alphanumeric information shown on one or more of the display panels 100a-100c.

In various embodiments, the control unit 94 generally comprises at least one microcontroller. The at least one microcontroller may include one or more processors, each of which may be embodied as a separate processor, an application specific integrated circuit (ASIC), a field programmable gate array (FPGA), or a dedicated electronic control unit.

The at least one microcontroller may be any sort of electronic processor (implemented in hardware, software executing on hardware, or a combination of both). The at least one microcontroller may also include tangible, non-transitory memory, (e.g., read-only memory in the form of optical, magnetic, and/or flash memory). For example, the at least one microcontroller may include application-suitable amounts of random-access memory, read-only memory, flash memory and other types of electrically-erasable programmable read-only memory, as well as accompanying hardware in the form of a high-speed clock or timer, analog-to-digital and digital-to-analog circuitry, and input/output circuitry and devices, as well as appropriate signal conditioning and buffer circuitry.

Computer-readable and executable instructions embodying the present method may be recorded (or stored) in the memory and executed as set forth herein. The executable instructions may be a series of instructions employed to run applications on the at least one microcontroller (either in the foreground or background). The at least one microcontroller may receive commands and information, in the form of one or more input signals from various controls or components in the platform 90 and communicate instructions to the display panels 100a-100c through one or more control signals to control the displays panels 100a-100c.

The display panels 100a-100c are generally mounted to the instrument panel 92. In various embodiments, one or more of the display panels 100a-100c may be disposed inside the platform 90 (e.g., vehicle 93). In other embodiments, one or more of the display panels 100a-100c may be disposed exterior to the platform 90. One or more display panels 100a-100c may implement an active public/privacy viewing modes. One or more display panels 100a-100c may also implement the privacy mode. As illustrated, the display panel 100a may be a cluster display positioned for use by a driver. The display panel 100b may be a console display positioned for use by the driver and a passenger. The display panel 100c may be a passenger display positioned for use by the passenger and the driver.

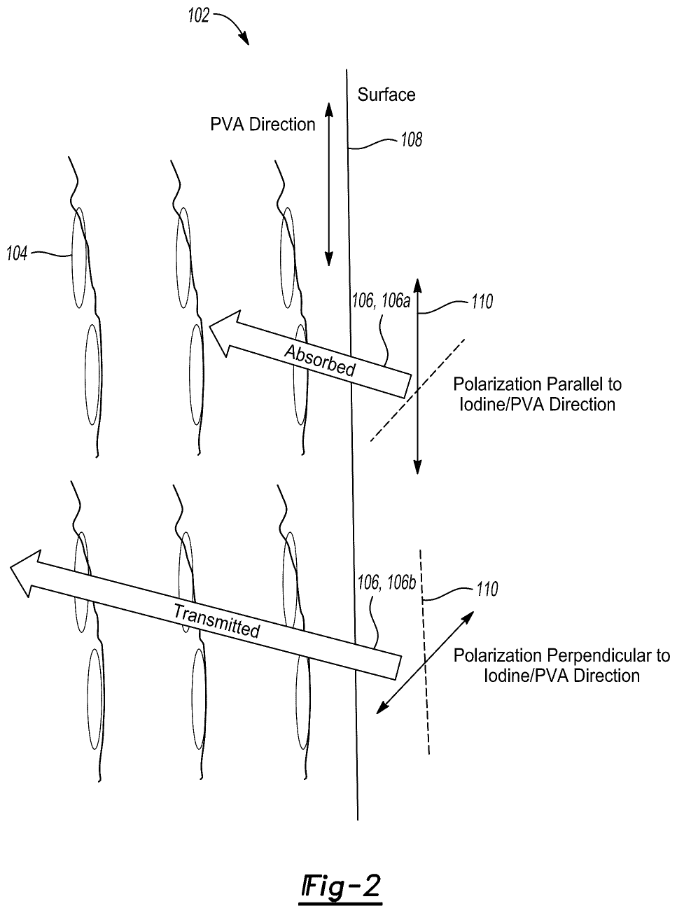

FIG. 2 illustrates a schematic diagram of an example operation of linear polarization dichroism in accordance with one or more exemplary embodiments. A passive dichroic dye material 102 is an organic molecule 104 that has a rodlike shape and displays an anisotropy in which different light absorption properties occur parallel and perpendicular to the molecule. The passive dichroic dye material optical characteristics are useful in absorptive linear polarizers (polyvinyl alcohol (PVA)/iodine chains). Chains within the passive dichroic dye material are generally aligned perpendicular to a particular surface.

The passive dichroic dye material 102 may receive a light 106 with a particular polarization oriented in a particular direction at a surface 108. The light 106a entering the surface 108 with a polarization parallel to one axis (e.g., parallel to an iodine/PVA direction 110) is absorbed by the passive dichroic dye material 102. The passive dichroic dye material 102 transmits a light 106b with a polarization perpendicular to the same axis (e.g., perpendicular to the iodine/PVA direction).

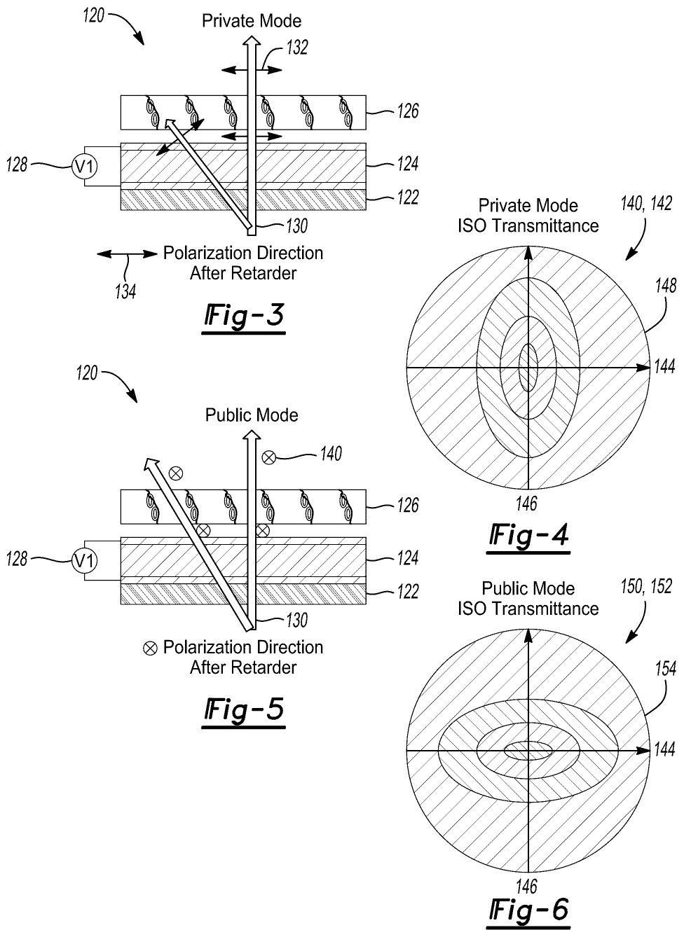

FIG. 3 illustrates a schematic side view of an example implementation of a first switchable privacy stack 120 (or cell) in the private mode in accordance with one or more exemplary embodiments. The first switchable privacy stack 120 generally includes a first polarizer 122, a first liquid crystal (LC) retarder 124 (e.g. in-plane switching (IPS), twisted nematic (TN), vertical alignment (VAN) or entry control block (ECB)), a dichroic dye film 126, and a voltage source 128.

The first polarizer 122 implements a linear polarizer. The first polarizer 122 received light 130 with a first polarization 132 (e.g., a horizontal polarization) oriented in a first direction 134 (e.g., a horizontal direction). The first polarizer 122 transmits the light 130 to the first liquid crystal retarder 124.

The first liquid crystal retarder 124 implements an active liquid crystal retarder (or liquid crystal retarder for short). The first liquid crystal retarder 124 is used to change a light polarization state between two perpendicular states based on a switching voltage V1. In first state, the polarization is horizontal 134 and so the off-axis light 130 has a large polarization component that is parallel to the dichroic dye absorption axis (e.g., the off-axis light is blocked), while the light 130 entering normal to the surface of the dichroic dye film 126 is transmitted. In second state, the vertical polarization of light 130 is perpendicular (e.g., both off-axis and on-axis) to an absorption axis of the dichroic dye film 126 and so is transmitted. (e.g., a restricted viewing angular range is in the vertical direction).

The dichroic dye film 126 implements a passive dichroic dye material. The passive dichroic dye film has a dichroic absorption axis. The dichroic absorption axis is perpendicular to a surface of the passive dichroic dye film.

The voltage source 128 implements an adjustable voltage source. The voltage source 128 is operational to generate the switching voltage V1 provided to the first liquid crystal retarder 124. A first voltage level of the switching voltage V1 may place the first liquid crystal retarder 124 in the first state to achieve the horizontal polarization of the light (e.g., the private mode, see FIG. 4). A second voltage level of the switching voltage V1 places the first liquid crystal retarder 124 in the second state to achieve the vertical polarization of the light (e.g., the public mode, see FIG. 6).

FIG. 4 illustrates a diagram 140 of an example transmittance of the first switchable privacy stack 120 in the private mode 142 in accordance with one or more exemplary embodiments. The diagram has a horizontal x-axis 144 and a vertical y-axis 146. The transmittance is illustrated as an International Organization for Standardization (ISO) transmittance.

In the private mode 142, the polarization of the light 130 is horizontal (e.g., left and right on the page as illustrated) and so the off-axis light (e.g., left and right of the y-axis 146) has the large polarization component parallel to the dichroic dye absorption axis. With the polarization component parallel to the dichroic dye absorption axis, the transmittance further away from the y-axis 146 is further restricted (e.g., off-axis light is blocked in the three inner ovals) relative to the possible field of view of the display (e.g., the outer circle). The light 130 that is normal to the surface of the passive dichroic dye film 126 (FIG. 3) and has the horizontal polarization is transmitted through the passive dichroic dye film 126. Therefore, the on-axis light has a higher transmittance (e.g., in the three inner ovals) above and below the x-axis 144 relative to the off-axis transmittance to the left and the right of the y-axis 146.

FIG. 5 illustrates a schematic side view of an example implementation of a first switchable privacy stack 120 in the public mode in accordance with one or more exemplary embodiments.

In the public mode, the polarization 148 of the light is normal to the surface of the passive dichroic dye film 126 (e.g., vertical polarization into and out of the page as illustrated). Therefore, the light 130 is transmitted through the passive dichroic dye film 126 in both the on-axis direction and the off-axis directions.

FIG. 6 illustrates a diagram 150 of an example transmittance of the first switchable privacy stack 120 in the public mode 152 in accordance with one or more exemplary embodiments. The diagram has the horizontal x-axis 144 and the vertical y-axis 146. The transmittance 154 is illustrated as the International Organization for Standardization (ISO) transmittance.

In the public mode 152, the polarization of the light 130 is vertical (e.g., into and out of the page as illustrated) and so the off-axis light (e.g., left and right of the y-axis 146) has the large polarization component perpendicular to the dichroic dye absorption axis. With the polarization component perpendicular to the dichroic dye absorption axis, the off-axis transmittance further away from the y-axis 146 is restricted (e.g., the off-axis light intensity is further reduced from the inner oval to the outer oval) relative to the possible field of view of the display (e.g., the outer circle). The light 130 that is normal to the surface of the passive dichroic dye film 126 and has the vertical polarization is transmitted through the passive dichroic dye film 126. Therefore, the on-axis transmittance further away from the x-axis 144 is reduced (e.g., the on-axis light intensity is reduced from the inner oval to the outer oval) above and below the x-axis 144 relative to the off-axis transmittance to the left and the right of the y-axis 146.

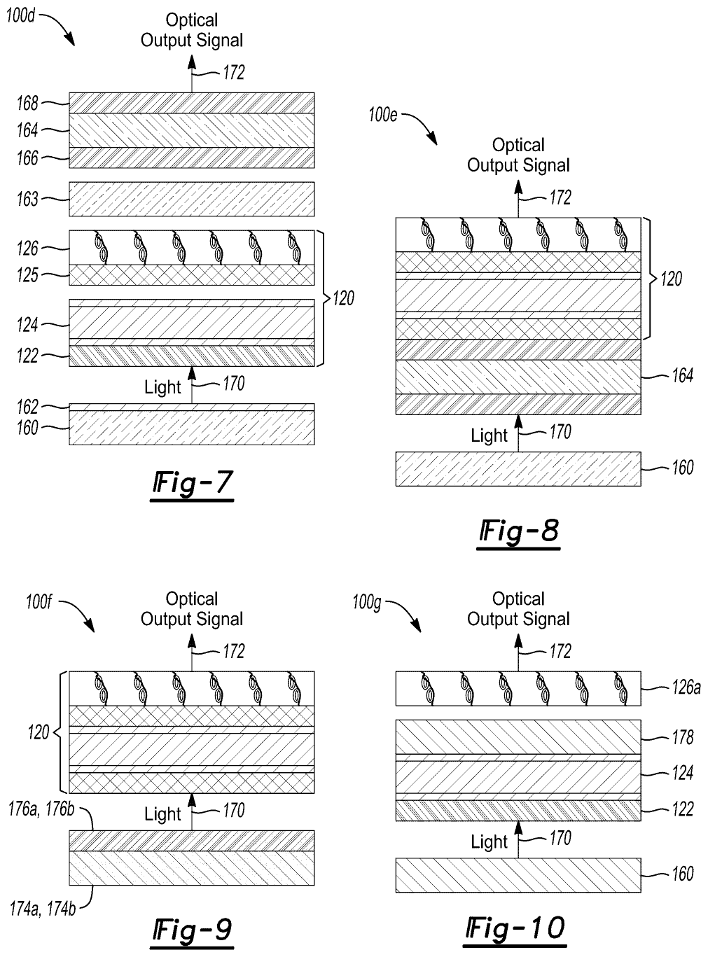

FIG. 7 illustrates a schematic side view of an example implementation of a first embodiment of a display panel 100d in accordance with one or more exemplary embodiments. The display panel 100d may be representative of one or more of the display panels 100a-100c. The display panel 100d generally includes a backlight source 160, an optional dual brightness enhancement film 162 (or filter), the first switchable privacy stack 120 (e.g., the polarizer 122, the liquid crystal retarder 124, an optical clear adhesive (OCA) layer 125, the passive dichroic dye film 126, the voltage source (not shown), an optional compensated half-wave plate 163, and a thin-film transistor display 164 with a rear linear polarizer 166 and a front linear polarizer 168.

The backlight source 160 implements an edge backlight source or a matrix backlight source. The backlight source 160 is operational to generate and present the light 170 to the dual brightness enhancement film 162 (where implemented) or else the first switchable privacy stack 120.

The optional dual brightness enhancement film 162 (DBEF) implements a reflective polarizer used to recycle light and create brighter images in the optical output signal 172 and wide angles. The dual brightness enhancement film 162 is mounted to the backlight source 160 and transfers the light 170 from the backlight source 160 to the first switchable privacy stack 120. The dual brightness enhancement film 162 is available as 3M™ Dual Brightness Enhancement Film from THE 3M COMPANY, with headquarters located in Maplewood, MN.

The optically clear adhesive layer 125 implements a transparent glue that couples the first liquid crystal retarder 124 to the passive dichroic dye film 126. Additional optically clear adhesive layers may be implemented to optically connect and physically connect the various layers together in the display.

The thin-film transistor display 164 implements a transmissive display. The thin-film transistor display 164 is mounted adjacent to either the optional compensated half-wave plate 163 (where implemented) or the first switchable privacy stack 120. The thin-film transistor display 164 is operational to modulate the light as received from the compensated half-wave plate 163 or the first switchable privacy stack 120. The modulation may be a change in opaqueness in different areas as controlled by a display signal. The changes in opaqueness generally modulate the intensity and the color to generate images in the optical output signal 172. The thin-film transistor display 164 may be a color display or a black-and-white display. Other transmissive display technologies may be implemented to meet the design criteria of a particular application.

FIG. 8 illustrates a schematic side view of an example implementation of a second embodiment of the display panel 100e in accordance with one or more exemplary embodiments. The display panel 100e may be representative of one or more of the display panels 100a-100d. The display panel 100e generally includes the backlight source 160, the thin-film transistor display 164, and the first switchable privacy stack 120. In the second embodiment, the thin-film transistor display 164 is located between the backlight source 160 and the first switchable privacy stack 120. The first switchable privacy stack 120 may be bonded to the thin-film transistor display 164. Additional polarizers and/or half-wave plates may be implemented to meet the design criteria of particular applications.

FIG. 9 illustrates a schematic side view of an example implementation of a third embodiment of the display panel 100f in accordance with one or more exemplary embodiments. The display panel 100f may be representative of one or more of the display panels 100a-100e. The display panel 100f generally includes an organic light-emitting diode display 174a or a micro light-emitting diode display 174b, and the first switchable privacy stack 120. In the third embodiment, a light-emitting diode display 174a, 174b is used instead of the thin-film transistor display 164 (FIG. 8) and the backlight source 160 (FIG. 8). The light-emitting diode display 174a, 174b is operational to generate the light 170 and create the images therein. Where an organic light-emitting diode display 174a is implemented, a circular polarizer 176a is mounted between the organic light-emitting diode display 174a and the first switchable privacy stack 120. Where a micro light-emitting diode display 174b is implemented, a linear polarizer 176b is mounted between the micro light-emitting diode display 174b and the first switchable privacy stack 120. The light 170 with the images is transferred through the first switchable privacy stack to create the optical output signal 172.

FIG. 10 illustrates a schematic side view of an example implementation of a fourth embodiment of the display panel 100g in accordance with one or more exemplary embodiments. The display panel 100g may be representative of one or more of the display panels 100a-100f. The display panel 100g generally includes the backlight source 160, the first polarizer 122, the first liquid crystal retarder 124, the quarter-wave plate 178, and a circular polarization passive dichroic dye film 126a.

The display panel 100g is not limited to linear polarization dichroism and may use circular polarization dichroism. The quarter-wave plate 178 is mounted between the first liquid crystal retarder 124 and the dichroic element exhibiting the circular polarization dichroism. The linear polarization of the light presented from the first liquid crystal retarder 124 is changed to a circular polarization by the quarter-wave plate 178. The circular polarization may be right-hand or left-hand circularly polarized light. The passive dichroic dye film 126a has selective transmission of light depending on the direction of circular polarization.

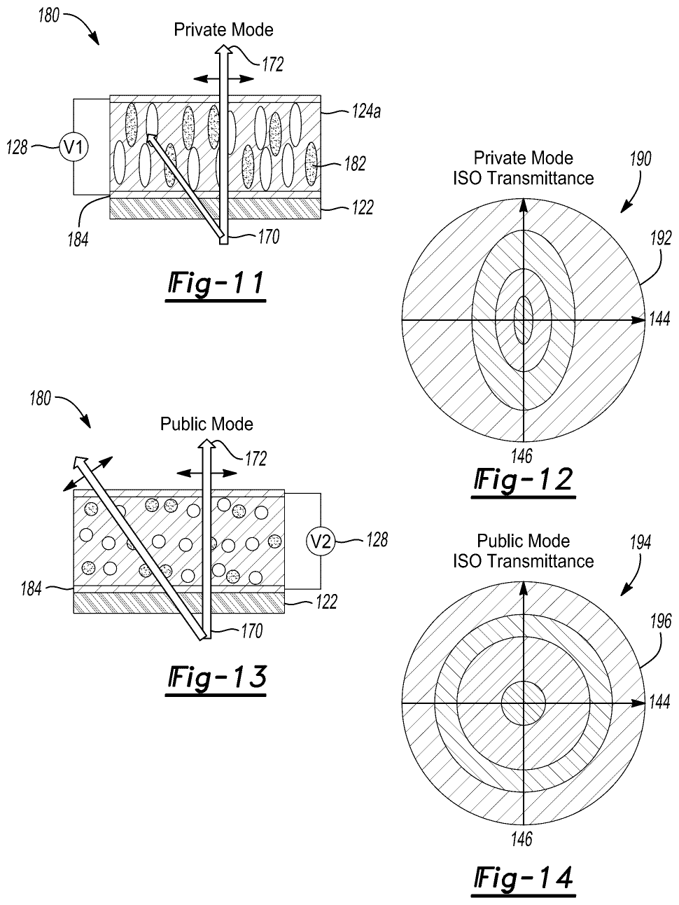

FIG. 11 illustrates a schematic side view of an example implementation of a second switchable privacy stack 180 in the private mode in accordance with one or more exemplary embodiments. The second switchable privacy stack 180 may be a variation of the first switchable privacy stack 120. The second switchable privacy stack 180 generally includes the first polarizer 122, a second liquid crystal retarder 124a, and the voltage source 128. The second liquid crystal retarder 124a contains the active dichroic dye particles 182.

The second liquid crystal retarder 124a implements an active liquid crystal retarder that is doped with the active dichroic dye particles 182. The second liquid crystal retarder 124a is used to change a light polarization state between two perpendicular states based on a switching voltage. In first state (128=V1), the polarization is horizontal and so the off-axis light has a large polarization component that is parallel to the dichroic dye absorption axis (e.g., the off-axis light is blocked) while the light received normal to a surface 184 of the second liquid crystal retarder 124a is transmitted. In the second state (128=V2, see FIG. 13), the vertical polarization of light is perpendicular e.g., (both off-axis and on-axis) to absorption axis of the active dichroic dye particles 182 and so is transmitted (e.g., the restricted viewing angular range is in vertical direction).

The active dichroic dye particles 182 in the second liquid crystal retarder 124a have a dichroic absorption axis. In various embodiments, the dichroic absorption axis is perpendicular to the surface 184 of the second liquid crystal retarder. Other dichroic absorption axes may be implemented to meet the design criteria of particular applications. Liquid crystal directors of the second liquid crystal retarder 124a are oriented similar to the dichroic absorption axis. The liquid crystal directors are oriented normal to the surface 184 of the second liquid crystal retarder 124a in the private mode, and oriented parallel to the surface 184 of the second liquid crystal retarder 124a in the public mode.

FIG. 12 illustrates a diagram 190 of an example transmittance of the second switchable privacy stack 180 in the private mode in accordance with one or more exemplary embodiments. The diagram has the horizontal x-axis 144 and the vertical y-axis 146. The transmittance 192 is illustrated as the International Organization for Standardization (ISO) transmittance.

In the private mode, the polarization of the light 170 is horizontal (e.g., left and right on the page as illustrated) and so the off-axis light (e.g., left and right of the y-axis) has the large polarization component parallel to the dichroic dye absorption axis. With the polarization component parallel to the dichroic dye absorption axis, the transmittance 192 further away from the y-axis 146 is further restricted (e.g., the off-axis light is blocked in the three inner ovals) relative to the possible field of view of the display (e.g., the outer circle). The light that is normal to the surface 184 (FIG. 11) of the second liquid crystal retarder 124a and has the horizontal polarization is transmitted through the second liquid crystal retarder 124a. Therefore, the on-axis light has a higher transmittance 192 (e.g., in the three inner ovals) above and below the x-axis 144 relative to the off-axis transmittance to the left and the right of the y-axis 146.

FIG. 13 illustrates a schematic side view of an example implementation of the second switchable privacy stack 180 in the public mode in accordance with one or more exemplary embodiments.

In the public mode, the polarization of the light 170 is normal to the surface 184 of the second liquid crystal retarder 124a (e.g., vertical polarization into and out of the page as illustrated). Therefore, the light 170 is transmitted through the second liquid crystal retarder 124a in both the on-axis direction and the off-axis directions.

FIG. 14 illustrates a diagram 194 of an example transmittance of the second switchable privacy stack 180 (or active privacy cell) in the public mode in accordance with one or more exemplary embodiments. The diagram 194 has the horizontal x-axis 144 and the vertical y-axis 146. The transmittance 196 is illustrated as the International Organization for Standardization (ISO) transmittance.

In the public mode, the polarization of the light is vertical (e.g., into and out of the page as illustrated) and so the on-axis light and the off-axis light has the large polarization component perpendicular to the dichroic dye absorption axis. With the polarization component perpendicular to the dichroic dye absorption axis, the on-axis and the off-axis transmittance is gradually restricted (e.g., tapered among the three inner circles) regardless of the direction away from the origin relative to the possible field of view of the display (e.g., the outer circle).

FIG. 15 illustrates a schematic side view of an example implementation of a fifth embodiment of the display panel 100h in accordance with one or more exemplary embodiments. The display panel 100h may be representative of one or more of the display panels 100a-100g. The display panel 100h generally includes the backlight source 160, the optional dual brightness enhancement film (or filter) 162 (see FIG. 7), the second switchable privacy stack 180 (e.g., the polarizer, the liquid crystal retarder, active dichroic dye particles, the voltage source (not shown)), the optional compensated half-wave plate (HWP) 163 (see FIG. 7), and the thin-film transistor display 164 with the rear linear polarizer 166 and the front linear polarizer 168.

The thin-film transistor display 164 may be a color display or a black-and-white display. Other transmissive display technologies may be implemented to meet the design criteria of particular applications.

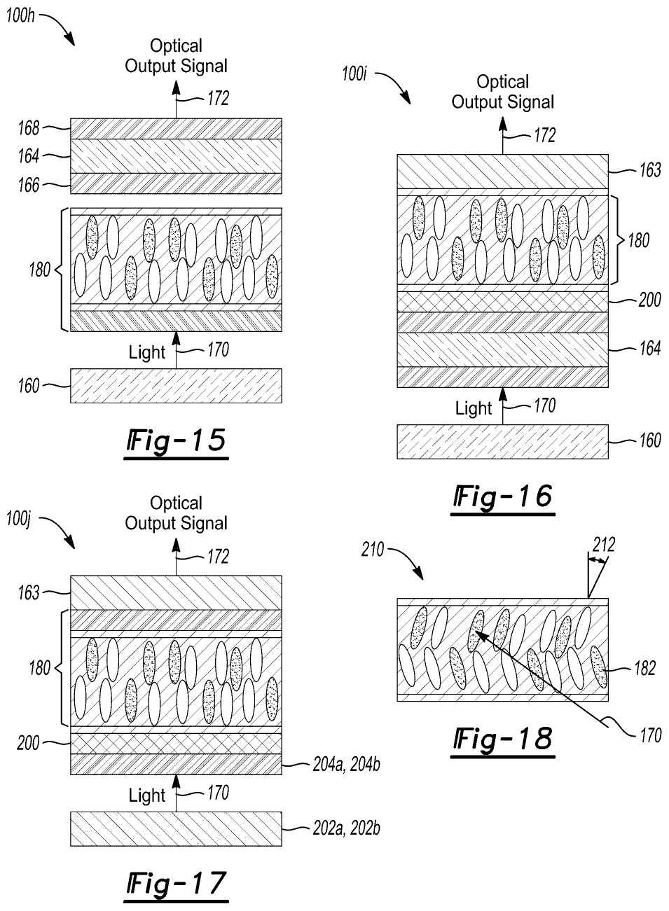

FIG. 16 illustrates a schematic side view of an example implementation of a sixth embodiment of the display panel 100i in accordance with one or more exemplary embodiments. The display panel 100i may be representative of one or more of the display panels 100a-100h. The display panel 100i generally includes the backlight source 160, the optional compensated halfwave plate 163, the thin-film transistor display 164, and the second switchable privacy stack 180.

In the sixth embodiment, the thin-film transistor display 164 is located between the backlight source 160 and the second switchable privacy stack 180. The second switchable privacy stack 180 may be bonded to the thin-film transistor display 164 by an optically clear adhesive 200. Additional polarizers and/or half-wave plates may be implemented to meet the design criteria of particular applications.

FIG. 17 illustrates a schematic side view of an example implementation of a seventh embodiment of the display panel 100j in accordance with one or more exemplary embodiments. The display panel 100j may be representative of one or more of the display panels 100a-100i. The display panel 100j generally includes the organic light-emitting diode display 202a or the micro light-emitting diode display 202b, and the second switchable privacy stack 180.

In the seventh embodiment, a light-emitting diode display 202b is used instead of the thin-film transistor display and the backlight source. The light-emitting diode display 202b is operational to generate the light and create the images therein. Where an organic light-emitting diode display 202b is implemented, a circular polarizer 204b is mounted between the organic light-emitting diode display 202b and the second switchable privacy stack 180. Where a micro light-emitting diode display 202a is implemented, a linear polarizer 204a is mounted between the micro light-emitting diode display 202a and the second switchable privacy stack 180. The light with the images is transferred through the second switchable privacy stack 180 to create the optical output signal 172.

FIG. 18 illustrates a schematic side view of an example implementation of another embodiment of the second liquid crystal retarder 210 in accordance with one or more exemplary embodiments.

A cut-off angle transmission may be optimized through a dichroic doped cell gap, a film thickness and/or dye concentration. For example, larger thicknesses or dye concentrations provide better off-axis blocking. In various embodiments, the active dichroic dye particles 182 in part of the second liquid crystal retarder 210 may be tilted at an angle 212 to establish a shallower privacy cut-off angle. The active dichroic dye particles 182 in another part of the second liquid crystal retarder 210 may be counter tilted to achieve symmetrical transmission. The symmetrical transmission may approach a peak transmission peak at the normal incidence of the light 170. The cut-off angle may also be tuned by adjusting the dye absorption axis tilt angle. In various embodiments, the second liquid crystal retarder 210 may have a x-cell configuration.

Embodiments of the present disclosure generally improve power efficiency through realizing active privacy using a single liquid crystal retarder. Furthermore, the switchable privacy stacks are not dependent on the backlight source, which opens up possible display panel applications to a range of possible display types.

The present disclosure may have various modifications and alternative forms, and some representative embodiments are shown by way of example in the drawings and will be described in detail herein. Novel aspects of this disclosure are not limited to the particular forms illustrated in the above-enumerated drawings. Rather, the disclosure is to cover modifications, equivalents, and combinations falling within the scope of the disclosure.

Those having ordinary skill in the art will recognize that terms such as “above,” “below,” “front,” “back,” “upward,” “downward,” “top,” “bottom,” etc., may be used descriptively herein without representing limitations on the scope of the disclosure. Furthermore, the present teachings may be described in terms of functional and/or logical block components and/or various processing steps. Such block components may be comprised of various hardware components, software components executing on hardware, and/or firmware components executing on hardware.

The foregoing detailed description and the drawings are supportive and descriptive of the disclosure, but the scope of the disclosure is defined solely by the claims. As will be appreciated by those of ordinary skill in the art, various alternative designs and embodiments may exist for practicing the disclosure defined in the appended claims.

1. A display panel comprising:
a first polarizer operational to transfer a light with a first polarization oriented in a first direction;
a first liquid crystal retarder mounted adjacent to the first polarizer, wherein:
the first liquid crystal retarder transfers the light received from the first polarizer in response to a control signal;
the control signal is switchable between a private mode and a public mode;
the private mode maintains the first polarization of the light oriented in the first direction; and
the public mode rotates the first polarization of the light to a second polarization oriented in a second direction; and
a passive dichroic dye film mounted adjacent to the first liquid crystal retarder, wherein:
the light with the first polarization in the private mode is absorbed by the passive dichroic dye film for off-axis incident angles in the first direction and transmitted for a normal incidence angle and the off-axis incidence angles in the second direction; and
the light with the second polarization in the public mode is transmitted for the normal incidence angle and the off-axis incidence angles in the first direction and absorbed for the off-axis incidence angles in the second direction; and
a display mounted adjacent to one of the passive dichroic dye film or the first polarizer, and operational to generate an image in the light in response to a display signal, wherein:
a private viewing angle of the image in the private mode is narrower than a public viewing angle of the image in the public mode.

2. The display panel according to claim 1, wherein:
the display is a thin-film transistor display.

3. The display panel according to claim 1, further comprising:
a second polarizer mounted between the first polarizer and the display, wherein:
the display an organic light-emitting diode display and the second polarizer is a circular polarizer; or
the display is a micro light-emitting diode display and the second polarizer is a linear polarizer.

4. The display panel according to claim 1, wherein:
the first polarization is a horizontal polarization oriented in a horizontal direction;
the second polarization is a vertical polarization oriented in a vertical direction; and
the passive dichroic dye film has a linear polarization dichroism.

5. The display panel according to claim 1, further comprising:
a quarter-wave plate disposed between the first liquid crystal retarder and the passive dichroic dye film.

6. The display panel according to claim 5, wherein:
the passive dichroic dye film has a circular polarization dichroism.

7. The display panel according to claim 6, wherein:
the circular polarization dichroism is a left-hand polarization.

8. The display panel according to claim 6, wherein:
the circular polarization dichroism is a right-hand polarization.

9. The display panel according to claim 1, further comprising:
a compensation layer mounted between the first liquid crystal retarder and the passive dichroic dye film.

10. The display panel according to claim 1, further comprising:
a backlight source mounted adjacent to the first polarizer and operational to generate the light.

11. A display panel comprising:
a first polarizer operational to transfer a light with a first polarization oriented in a first direction;
an active privacy cell mounted adjacent to the first polarizer, wherein:
the active privacy cell transfers the light received from the first polarizer in response to a control signal;
the active privacy cell includes a second liquid crystal retarder doped with active dichroic dye particles;
the second liquid crystal retarder has a director axis that is adjustable with the control signal;
the active dichroic dye particles have a dye absorption axis that is adjustable with the control signal;
the control signal is switchable between a private mode and a public mode;
in the private mode the light with the first polarization is transmitted for a normal incidence angle and is blocked for off-axis incidence angles; and
in the public mode the light with the first polarization is transmitted for the normal incidence angle and is transmitted for the off-axis incidence angles; and
a display mounted adjacent to one of the active privacy cell or the first polarizer and operational to generate an image in the light in response to a display signal, wherein:
a private viewing angle of the image in the private mode is narrower than a public viewing angle of the image in the public mode.

12. The display panel according to claim 11, wherein:
the display is a thin-film transistor display.

13. The display panel according to claim 11, further comprising:
a second polarizer mounted between the first polarizer and the display, wherein:
the display an organic light-emitting diode display and the second polarizer is a circular polarizer; or
the display is a micro light-emitting diode display and the second polarizer is a linear polarizer.

14. The display panel according to claim 11, wherein:
the first polarization is a horizontal polarization oriented in a horizontal direction.

15. The display panel according to claim 11, wherein:
liquid crystal directors of the second liquid crystal retarder and a die absorption axis of the active dichroic dye particles are oriented normal to a surface of the second liquid crystal retarder in the private mode.

16. The display panel according to claim 11, wherein:
liquid crystal directors of the second liquid crystal retarder and a die absorption axis of the active dichroic dye particles are oriented parallel to a surface of the active privacy cell in the public mode.

17. The display panel according to claim 11, further comprising:
a compensated half-wave plate mounted between the active privacy cell and the display.

18. The display panel according to claim 11, further comprising:
a quarter-wave plate disposed between the first polarizer and the active privacy cell, wherein:
the active dichroic dye particles have a circular polarization dichroism.

19. The display panel according to claim 11, wherein:
a cut-off angle of the active privacy cell is based on a tilt angle of the dye absorption axis.

20. The display panel according to claim 19, wherein:
the active privacy cell includes a counter tile angle symmetrical to the tilt angle to establish a transmission peak at normal incidence.
